(19) United States
(12) Patent Application Publication
(10) Pub. No.: US 2016/0077403 A1
(43) Pub. Date: Mar. 17, 2016

(54) OPTO-ELECTRIC FREQUENCY COMB GENERATOR

(71) Applicant: PURDUE RESEARCH FOUNDATION, West Lafayette, IN (US)

(72) Inventors: Andrew J. Metcalf, West Lafayette, IN (US); Daniel E. Leaird, West Lafayette, IN (US); Victor Torres-Company, Goteborg (SE); Andrew Marc Weiner, West Lafayette, IN (US)

(73) Assignee: PURDUE RESEARCH FOUNDATION, West Lafayette, IN (US)

(21) Appl. No.: 14/644,563

(22) Filed: Mar. 11, 2015

Related U.S. Application Data
(60) Provisional application No. 61/951,482, filed on Mar. 11, 2014.

(51) Int. Cl. G02F 1/35

(52) U.S. Cl. CPC G02F 1/353

(57) ABSTRACT

An optical comb generator, having a light input port configured to receive a continuous wave light from a laser source and a plurality of phase modulators coupled to the light input port. At least one intensity modulator is coupled to the plurality of the phase modulators, along with a plurality of phase shifters. The phase shifters are coupled to a corresponding phase modulator. A radio frequency (RF) clock is coupled to the phase modulators and the intensity modulator, and configured to provide synchronous clock input to the phase modulators and the intensity modulator. The comb generator may also incorporate an RF switch disposed between the RF clock and the phase shifters associated with a phase modulator, so that the RF switch enables tuning each corresponding phase shifter to thereby provide a tunable optical comb.

### RELATED APPLICATIONS

The present application claims the benefit of U.S. provisional application Ser. No. 61/951,482, filed Mar. 11, 2014 which is hereby incorporated by reference in its entirety.

### STATEMENT REGARDING GOVERNMENT FUNDING

This invention was made with government support under N00244-09-1-0068 awarded by the Naval Postgraduate School. The government has certain rights in the invention.

### TECHNICAL FIELD

This application relates to optical signal generation and optical modulation in optical communication and other applications.

### BACKGROUND

This section introduces aspects that may help facilitate a better understanding of the disclosure. Accordingly, these statements are to be read in this light and are not to be understood as admissions about what is or is not prior art.

Frequency comb generation is now a commonplace component in optical circuits. Mode locked lasers and fiber based frequency combs are typically limited to 100 s of MHz or low GHz repetition rates. In optical communication higher repetition rates are desired than can be generated with these traditional pulsed lasers.

Traditional mode locked lasers can produce broad bandwidth combs, however, they require complex setups which are difficult to tune and are limited by the need for higher repetition rates (e.g., 10 s of GHz). A different method to produce combs is through electro-optic comb generation, using phase modulators (PMs) and/or intensity modulators (IMs) driven by an RF (radio frequency) oscillator to modulate a continuous wave (CW) laser. Various combinations of phase modulators and intensity modulators have been used to create frequency combs. If used alone, a phase modulator can provide a number of discrete frequency components, typically 10-20, with varying spectral power about a center frequency of the CW, whereas an intensity modulator can provide a few frequencies with consistent spectral power about the center frequency of the CW. If both a phase modulator and intensity modulator are used together and carefully aligned, combs can be produced with a flat spectral profile which is desirable in optical communications. However, for many applications, combs with larger bandwidths, i.e. more comb lines, are desired. In order to increase the bandwidth of these combs, some have placed the modulator (intensity modulator or phase modulator) inside Fabry-Perot cavities to increase the bandwidth. However, in doing so, the comb is no longer tunable.

Therefore, a novel optical arrangement is needed to provide three important attributes, i.e., high phase coherence across the entire optical bandwidth, a flat spectral profile, and independent tunability of the repetition rate and frequency offset.

### SUMMARY

According to one embodiment, an optical comb generator is disclosed, comprising a light input port configured to receive a continuous wave light from a laser source, a plurality of phase modulators coupled to the light input port, at least one intensity modulator coupled to the plurality of the phase modulators, a plurality of phase shifters, each of the plurality of phase shifters coupled to a corresponding phase modulator of the plurality of phase modulators, a radio frequency (RF) clock coupled to the plurality of the phase modulators and to the at least one intensity modulator, configured to provide synchronous clock input to the phase modulators and the intensity modulator. At least one RF switch is optionally disposed between the RF clock and at least one of the plurality of the phase shifters associated with a phase modulator. An optical output port is configured to provide an optical comb, the at least one RF switch configured to tune each corresponding phase shifter to thereby provide a tunable optical comb.

### BRIEF DESCRIPTION OF THE DRAWINGS

FIG. 1a shows a schematic diagram of a comb generator system according to one embodiment.

FIG. 1b shows a schematic diagram of a comb generation system incorporating low pass filtering according to a further embodiment.

FIG. 2 shows spectral traces for 7, 10, and 17 GHz, respectively, for an example test using the system of FIG. 1b.

FIG. 3a shows an autocorrelation trace for an example test using the system of FIG. 1b.

FIG. 3b shows the total programmed phase along with its best quadratic fit for an example test using the system of FIG. 1b.

FIG. 4 shows spectral traces acquired at 0.01 nm resolution every 30 seconds over an hour plotted together using the system of FIG. 1b.

FIG. 5 shows time-domain sampled waveforms using the system of FIG. 1b.

FIG. 6a shows measurements comparing the single-sideband (SSB) noise RF spectrum of the RF oscillator and first tone of the photo detector intensity of the comb generator system of FIG. 1b operating at 7 GHz.

FIG. 6b shows measurements comparing the single-sideband (SSB) noise RF spectrum of the RF oscillator and first tone of the photo detector intensity of the comb generator system of FIG. 1b operating at 10 GHz.

FIG. 6c shows measurements comparing the single-sideband (SSB) noise RF spectrum of the RF oscillator and first tone of the photo detector intensity of the comb generator system of FIG. 1b operating at 17 GHz.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

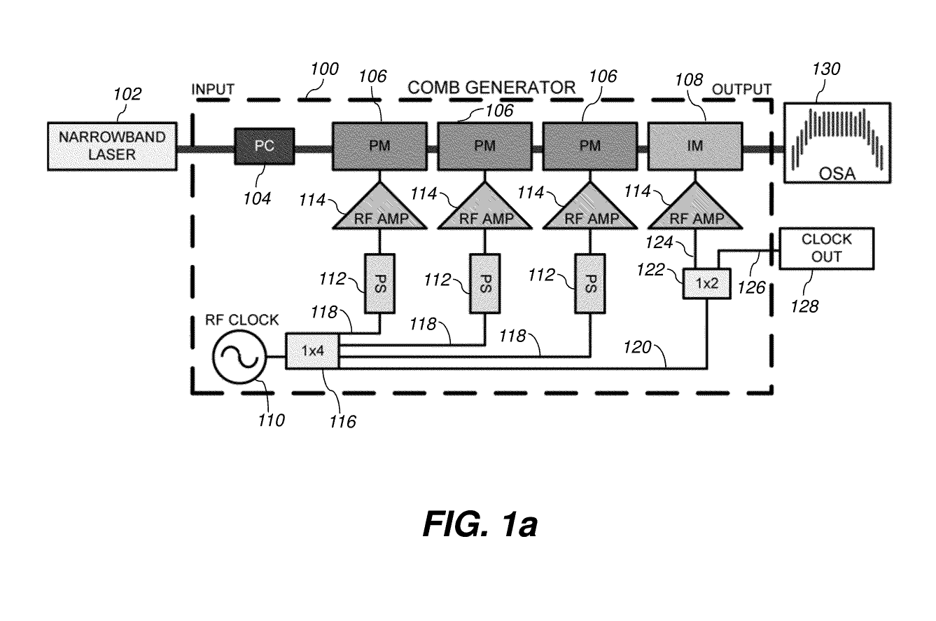

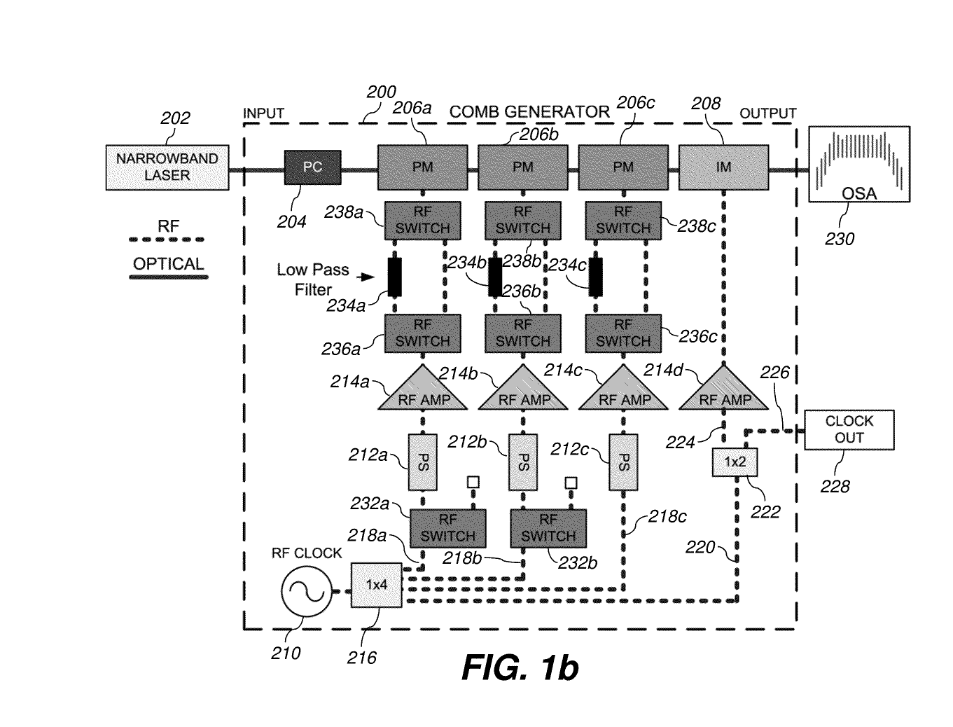

According to the present disclosure, a novel optical-electrical arrangement is provided which includes cascading multiple phase modulators to increase output bandwidth while maintaining tunability. The novel arrangement further provides an improvement for ease of tuning by introducing a novel RF switching arrangement. Referring to FIG. 1a, a comb generator 100, according to one embodiment of the present disclosure is provided. The comb generator 100 includes a narrow-linewidth continuous wave (CW) fiber laser source 102 providing an optical continuous-wave through a polarization controller (PC) 104. The optical output of the polarization controller 104 is directed through a plurality of electro-optic phase modulators (PMs) 106 and one electro-optic intensity modulator (IM) 108, which are all driven by a tunable RF oscillator (clock) 110. The intensity modulator 108 is carefully biased to carve out a flat-top pulse train from the CW laser source 102.

The comb generator 100 of the present disclosure further includes an RF phase shifter (PS) 112 for each phase modulator 106. The phase shifters 112 align the cusp of the phase modulation from every phase modulator 106 with the peak of the flat top pulse. The optical bandwidth of the comb is proportional to the modulation index introduced by the cascade of phase modulators 106.

The comb generator 100 of FIG. 1a, further includes a radio frequency amplifier (RF AMP) 114 for each of the modulators 106 and 108, and a phase shifter 112 for each of the phase modulators 106. The RF clock 110 provides a signal to a ¼ RF splitter 116 which then feeds each of the three phase shifters 112 with a synchronous split RF signal 118. The last output 120 of the ¼ RF splitter 116 is optionally fed to a ½ splitter 122 which provides one of its outputs 124 as a synchronous signal to the RF AMP 114, and the other output 126 as a clock output 128 from the comb generator 100. It shall be understood that other types and configurations of splitter (e.g., different number of output channels) may be used for RF splitters 116 and 122. The output RF clock 128 can be used to synchronize with an external device, such as a data modulator, or a trigger for a measurement device like an. The output of the intensity modulator 108 can be used as the output of the comb generator 100 to feed, for example, an optical spectrum analyzer (OSA) 130.

Referring to FIG. 1b, another comb generator 200, similar to comb generator 100, is provided according to a further embodiment of the present disclosure. The comb generator 200 is configured to receive a narrow-linewidth (<10 kHz) CW fiber laser source 202 providing a continuous-wave through a polarization controller (PC) 204. The optical output of the polarization controller is directed through a plurality of electro-optic phase modulators (PMs) 206a, 206b, 206c and one electro-optic intensity modulator (IM) 208, which are all driven by a tunable RF oscillator (clock) 210. It should be appreciated that other CW laser inputs can be used. Each phase modulator 206 has a bandwidth of 20 GHz, in at least one exemplary embodiment. The intensity modulator 208 (which preferably has a Vπ˜5.5V at 10 GHz) is carefully biased to carve out a flat-top pulse train from the CW laser source 202.

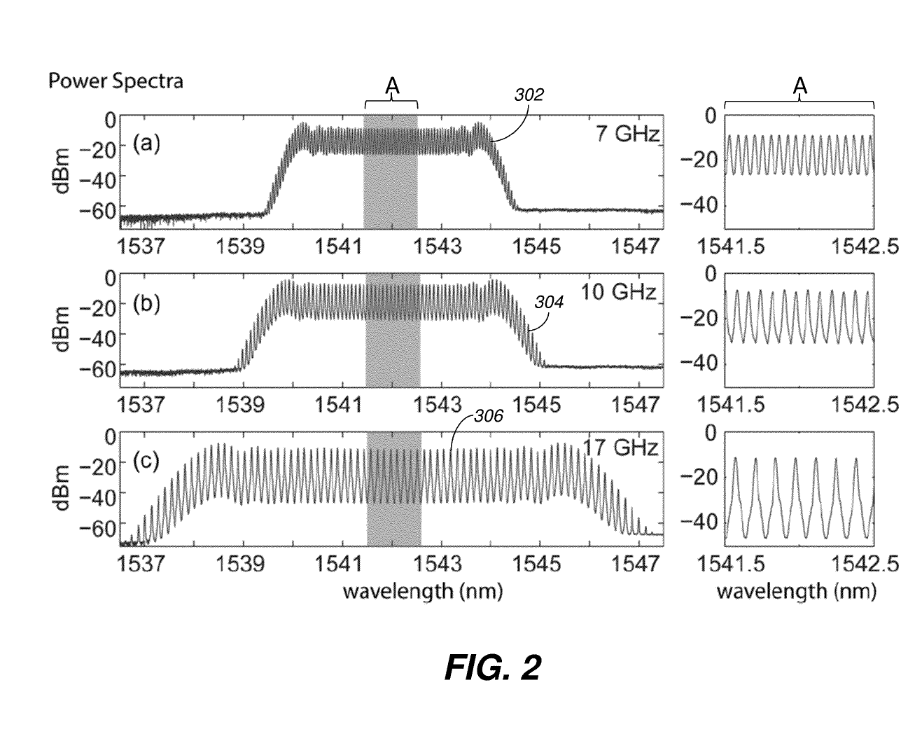

The comb generator 200 of the present disclosure further includes an RF phase shifter 212 (shown 212a, 212b, 212c), for each phase modulator 206 which aligns the cusp of the phase modulation from every phase modulator 206 with the peak of the flat top pulse. This alignment is carried out so the pulses align with the peak of phase modulation where the applied phase can be approximated as nearly quadratic. A perfect quadratic phase is referred to as a time-lens. Narrower pulses represent better approximation of the applied phase to purely quadratic, and thus are capable of achieving a flatter spectrum. Referring to the output spectrums in FIG. 2, discussed further below, small “ears” are observed on the edge of the spectrum. These “ears” arise because the applied phase is not exactly quadratic. Adding an additional intensity modulator 208 would shorten the pulse and result in a flatter spectral profile.

The optical bandwidth of the comb is proportional to the modulation index introduced by the cascade of phase modulators 206. Each phase modulator has Vπ˜3.5V at 10 GHz and is capable to sustain 1 W of RF power, leading to a bandwidth of more than 20 lines within −10 dB bandwidth per phase modulator 206.

The RF clock 210 provides a signal to a ¼ RF splitter 216 which then feeds each of the three phase shifters 212, with a synchronous split RF signal 218 (shown as 218a,218b,218c). The last output 220 of the ¼ RF splitter 216 is optionally fed to a ½ splitter 222 which provides one of its outputs 224 as a synchronous signal to the intensity modulator's 208 RF AMP 214d, and the other output as a clock output 228 from the comb generator 200. It shall be understood that other types and configurations of splitter (e.g., different number of output channels) may be used for RF splitters 116 and 122. The output RF clock 228 can be used to synchronize with an external device, such as a data modulator, or a trigger for a measurement device like an oscilloscope. The ¼ split RF clock outputs 218a, 218b are directed through RF Switches 232a and 232b to phase shifters 212a and 212b, respectively, while the third ¼ split clock output 218c is fed to the phase shifter 212c directly.

The comb generator further includes a low pass filter 234 (shown as 234a, 234b, 234c) disposed between two RF switches 236 (distal) and 238 (proximal) for each phase modulator 206. The distal RF switches are shown as 236a, 236b, 236c, while the proximal RF switches are shown as 238a, 238b, 238c. These RF switches 236 and 238 are preferably controlled by one controller (e.g., an electrical switch (not shown) to move from one side, e.g., the side having the low pass filter, to the other side (i.e., the side which does not have an low pass filter). Furthermore, each grouping of phase modulators 206 also includes an RF amplifier 214 (shown as 124a, 124b, 124c) coupled to each distal RF switch 238. In addition to the switch bank consisting of switches 236 and 238, the RF switches 232a and 232b are coupled to two of the phase modulators, 206a and 206b, respectively. These switches (232a and 232b) allow the user to turn off RF power to their corresponding phase modulator (206a or 206b), leaving only one phase modulator (206c) and the intensity modulator 208 receiving the RF signal from RF clock 210. Starting with two phase modulators (206a and 206b) switched off, the remaining phase modulator 206c and the intensity modulator 208 can be easily aligned using the phase modulators corresponding phase shifter 212c. After the 1st phase modulator 206c is aligned, the 2nd phase modulator (either 206a or 206b) can be turned on and aligned and so on.

Therefore, one of the phase shifters (in the case shown in FIG. 1b, 212c) receives its RF clock signal directly from the ¼ splitter 216.

The arrangement of the comb generator 200 of FIG. 1b incorporates the first two phase modulators (206a and 206b) with high-power handling capabilities (up to 1 W) while keeping low loss, and the comb delivers maximum of 13-15 dBm output power at 10 GHz repetition rate. It should be noted that placement of intensity modulators and phase modulators is arbitrary in this type of comb generation configuration. If intensity modulators (one or more) are placed before the phase modulators the device would function in the same manner. However, if it is desired for the comb to handle, e.g., 1 Watt of optical power, one or more (in this case two) high optical power handling phase modulators can be placed at the input. Due to the insertion loss of the phase modulators the input optical power is diminished sufficiently by the time it reaches the 3rd phase modulators and intensity modulator. If, however, the intensity modulator was placed first it would not be able to receive 1 Watt of optical power.

When dealing with multiple phase modulators, it is important to correctly align the chirp from each phase modulator with the peak of the pulses from the intensity modulator. This is not a straightforward task when all modulators are running at once. Usually, it requires disconnecting the phase modulator's from the setup and aligning them one by one. To expedite the tuning process, RF switches 232a and 232b were installed in-line with two of the phase modulators 206a and 206b (compare the comb generator 100 of FIG. 1a with the comb generator 200 of FIG. 1b). These RF switches 232a and 232b allow selection of each phase modulator 206 and phase alignment of the amplified RF signal with the aid of the corresponding phase shifter.

When operating the comb at repetition rates of 11 GHz and below, the second harmonic generated in the RF high-power amplifier falls within the bandwidth of the phase modulator 206. This second harmonic distorts the linear chirp and degrades the quality of the comb. These distortions need to be filtered out while still achieving operation over the full tunable range (6-18 GHz). The solution to the distortion according to the present disclosure was to install a set of two RF switches (each pair of 236 and 238) after each RF amplifier 214a, 214b, and 214c. The first switch (236) of each pair after the amplifier selects between two paths, one with a filter 234 (e.g., K&L 6L250-12000/T26000) and one without (see FIG. 1b). The second switch simply recombines the chosen path with the input of the phase modulator 206. This allows the user to select the operation mode between 6-11 GHz (path with filter 234) or 11-18 GHz (path without filter 234).

The resulting frequency comb generator 200 is broadly tunable in repetition rate. By changing the RF clock 210 frequency one can change the channel spacing between comb teeth. The tunable range is limited by the bandwidth of the RF-amplifiers from 6-18 GHz. After setting the clock repetition rate, the comb can be re-optimized quickly, using the RF phase shifters 212 to align the cusps of the phase modulation with the flat-top pulses. Using the RF switches, the selection and alignment of the individual phase modulators may result in a total manual tuning time of around 1 minute.

Referring to FIG. 2, spectral traces 302, 304, 306 are shown for 7, 10, and 17 GHz, respectively, for an example test using the system of FIG. 1b. The limited extinction ratio of the comb lines at the lower repetition rates is attributed to the limited resolution (0.01 nm) of the optical spectrum analyzer (OSA). In these measurements the comb was operated with 1 W optical input power, which corresponds to the maximum sustainable power of the first two phase modulators 206a and 206b. As discussed above, only the first two phase modulators, 206a and 206b, have high optical power handling. The third phase modulator, 206c, can only handle 27 dBm of optical input power, according to at least one embodiment. The output spectrum shows roughly −15 to −17 dB loss for all three repetition rates, which is typical across the full tuning range. The majority of the loss can be attributed to the insertion loss of the optical components, 3 dB for each phase modulator 206 and 2 dB for the intensity modulator 208. This provides a high maximum output power from 13 to 15 dBm. The grayed area in each of the graphs in the left column of FIG. 2 is expanded (zoomed) on the right column of FIG. 2.

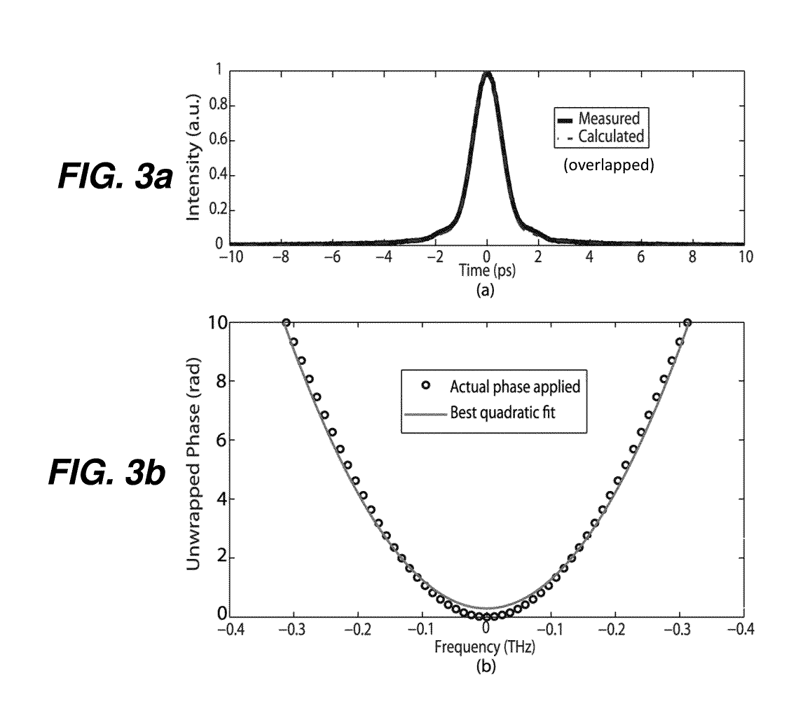

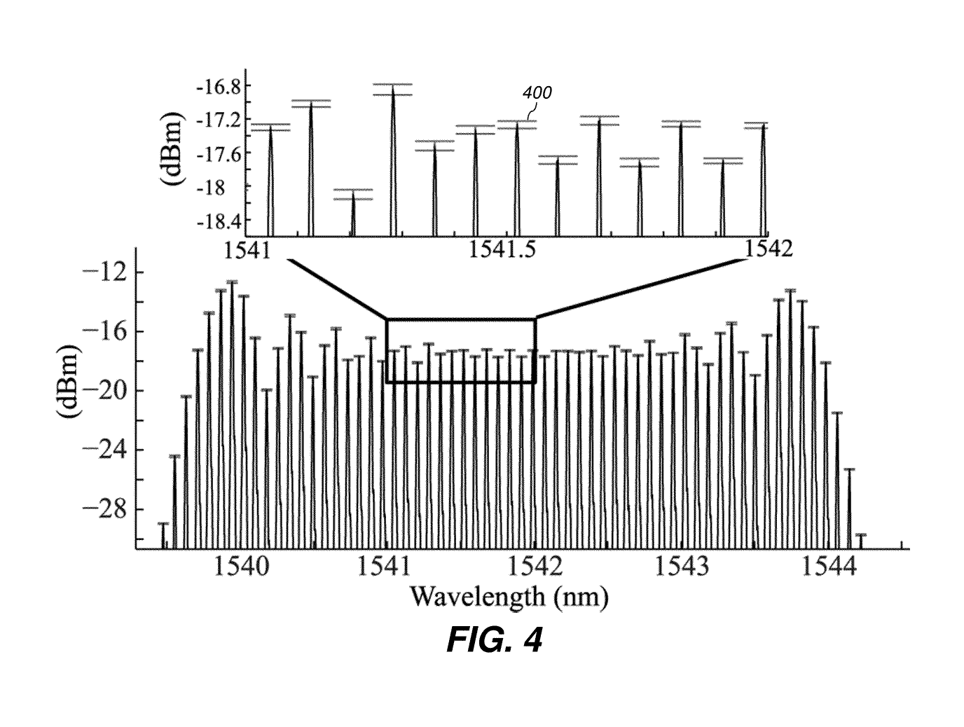

In order to test the coherence of the source 202, a comb at 12 GHz is generated, then compressed via line-by-line pulse shaping using a commercial pulse shaper (e.g., a FINISAR WAVESHAPER 1000S). If the pulse is compressible to the bandwidth limited duration, a high-degree of spectral phase coherence is inferred. An autocorrelation trace is optimized in an iterative process by compensating for even-order terms of spectral phase up to eight. The autocorrelation trace is shown in FIG. 3(a). The optimization procedure is complete after the final phase modulator is aligned, at that point there is a substantially flat broadband comb. If it is desired to compress the pulses in the time domain, the spectral phase needs to be compensated for. This can be done with a pulse shaper, or alternatively by sending the output of the comb through a specific amount of optical fiber, indicative of high phase coherence between the different comb lines. If there was no phase coherence the pulses could not be compressed. In many applications compressed optical pulses are desired. However, the pulse shaper or optical fiber (used for compression) are not in the scope of the comb generator, i.e. they are not needed to produce the flat-top comb, they can be used to show the comb can be compressed into pulses if desired.

The measured trace is compared to its calculated counterpart assuming a transform-limited pulse using the measured spectrum. As shown, the agreement between the curves is excellent, demonstrating high spectral-phase stability in the source.

Although up to an 8th order correction was used with a shaper, the total phase applied was almost purely quadratic. For comparison, FIG. 3(b) shows the total programmed phase along with its best quadratic fit. Because the phase compensation is nearly quadratic, it allows for near band-limited pulse compression with dispersive fiber alone.

The stability of the source is measured by letting it free-run over the course of one hour, while monitoring the optical spectrum with the OSA. Spectral traces were acquired at 0.01 nm resolution every 30 seconds for the duration of the measurement. All of the spectral traces recorded over the duration of the measurement, are plotted together in FIG. 4. The results shown in FIG. 4 are indicative of two important factors. A series of traces over the full measurement duration were considered and then plotted on top of each other. No average was taken. Next, the standard deviation was calculated in the peak intensity for each comb line, and the standard deviation was then plotted in the form of the horizontal error bars 400. The standard deviation of the measured peak fluctuations is shown in the error bars overlaying the spectral traces, showing a maximum standard deviation of 0.15 dBm.

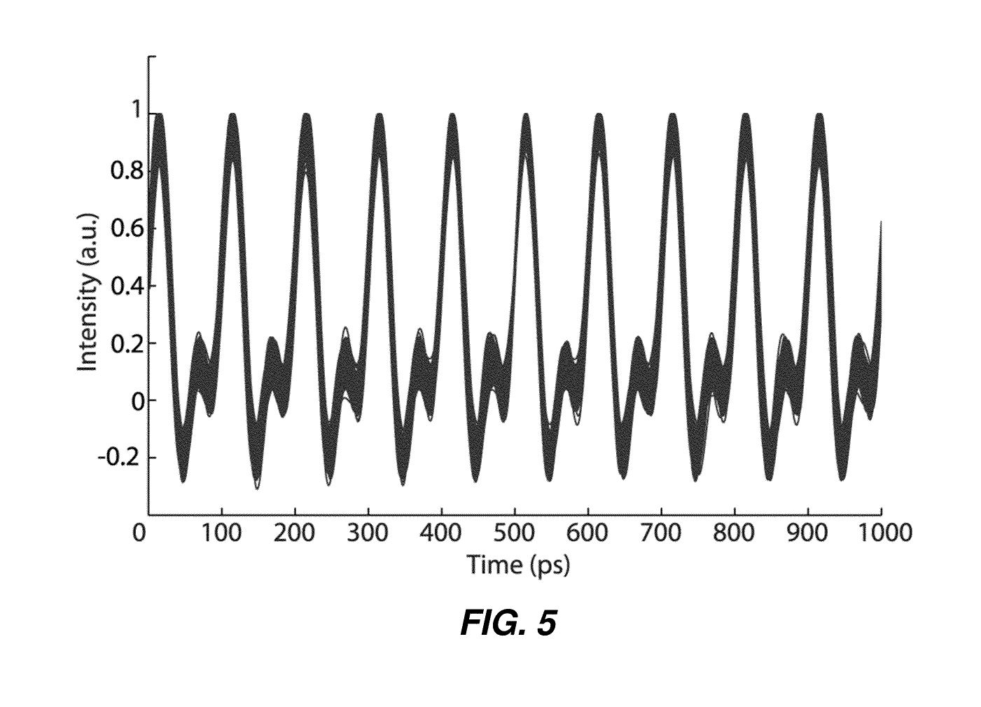

In addition, a separate measurement was taken in the time domain. The output of the comb generator 200 was first compressed with a pulse shaper before being converted to the electrical domain via a 22 GHz photodetector (PD) and measured by a real-time scope (e.g., TEKTRONIX DSA72004B). The waveform was sampled at 50 Gsamples/s, with a trace recorded every four seconds for a total of one hour. FIG. 5, shows all of the sampled waveforms overlaid together. The maximum peak deviation is ˜%12 of the overall pulse amplitude.

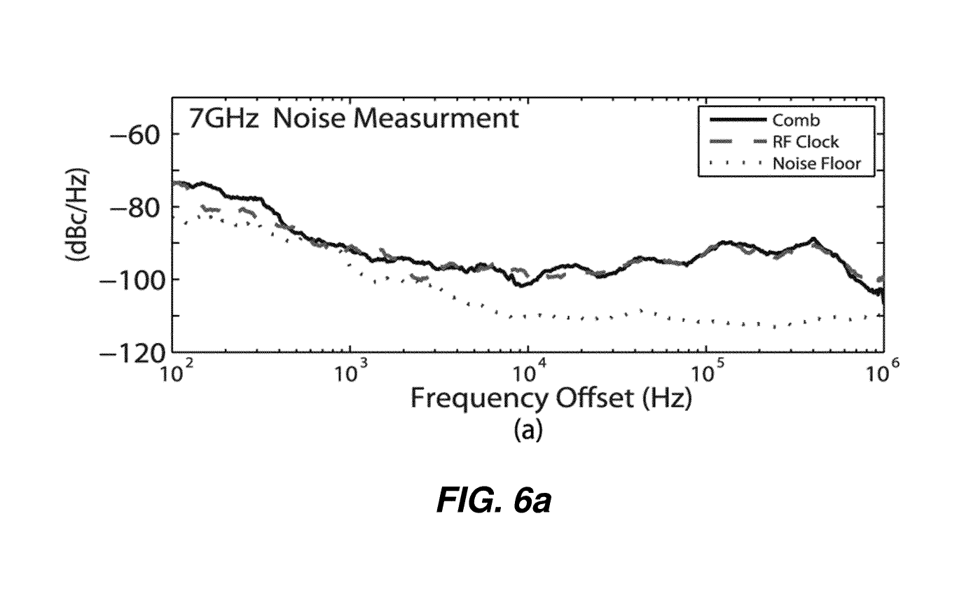

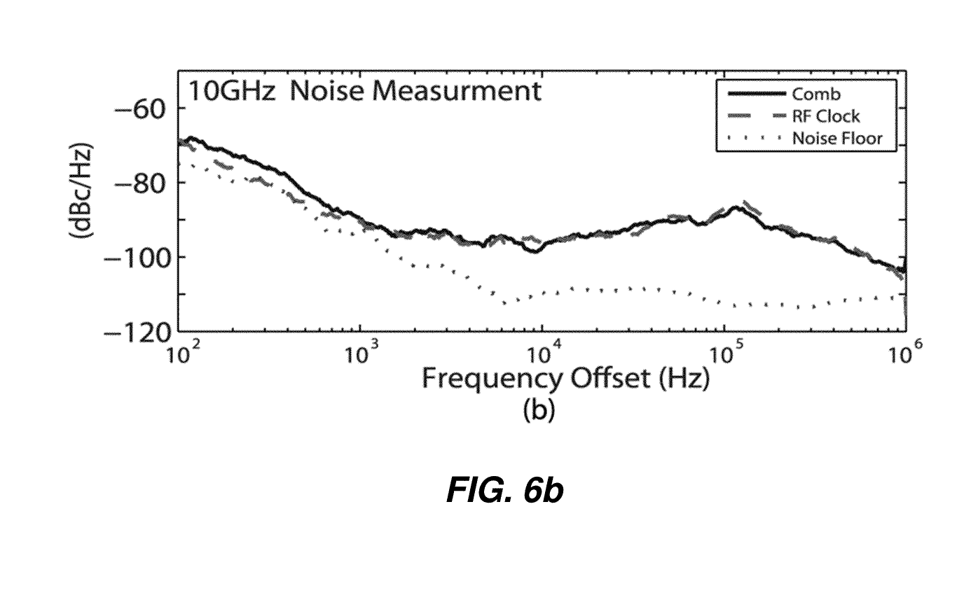

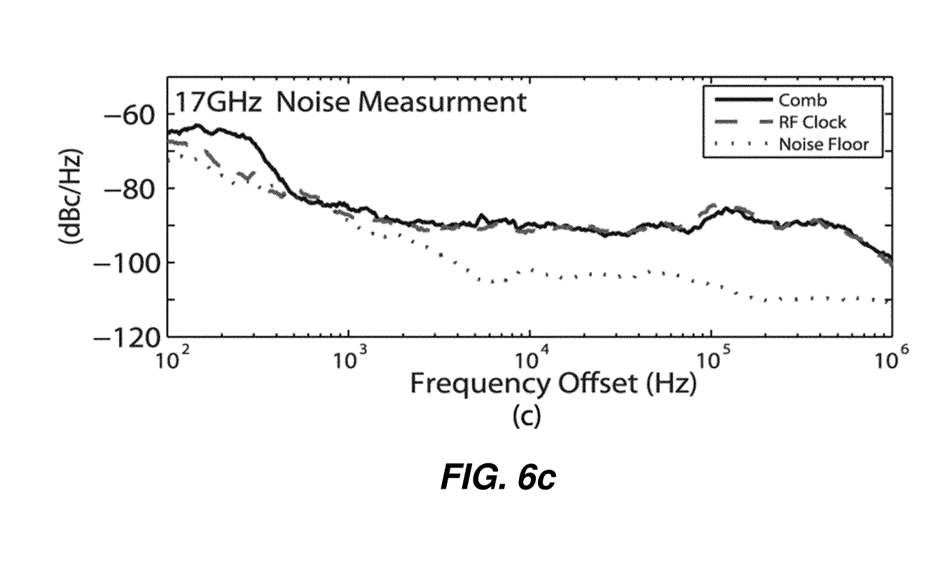

Measurements comparing the single-sideband (SSB) noise RF spectrum of the RF oscillator and first tone of the PD intensity of the comb generator 200 according to the present disclosure are displayed in FIGS. 6a, 6b, and 6c. The measurements were carried out for three repetition rates, 7, 10, and 17 GHz (shown in FIGS. 6a, 6b, and 6c, respectively). The pulses were first compressed with the aid of the pulse shaper to their near transform-limited duration. The spectral phase of the comb is compensated for in order to induce phase-to-intensity conversion from the three phase modulator stage. This compensation is carried out to make sure that the contribution to the SSB RF spectrum from the phase modulators is properly taken into account. The optical intensity is converted to the RF domain via a 22 GHz photodiode. The RF signal was then amplified using two RF amplifiers (MITEQ AMF-6D and MINI-CIRCUITS ZVE-2W-183+) before being measured using the RF phase-noise utility of the electrical spectrum analyzer. For completeness, the noise measurements of the tunable RF oscillator (HITTITE HMC-T2100) for each frequency, as well as the noise floor of the analyzer, are also shown. The Phase noise of the comb matches almost exactly with that of the RF oscillator alone; indicating purity degradation of the tone in the comb generation process is insignificant.

Those skilled in the art will recognize that numerous modifications can be made to the specific implementations described above. The implementations should not be limited to the particular limitations described. Other implementations may be possible.

1. An optical comb generator, comprising:
a light input port configured to receive a continuous wave light from a laser source;
a plurality of phase modulators coupled to the light input port;
at least one intensity modulator coupled to the plurality of the phase modulators;
a plurality of phase shifters, each of the plurality of phase shifters coupled to a corresponding phase modulator of the plurality of phase modulators;
a radio frequency (RF) clock coupled to the plurality of the phase modulators and to the at least one intensity modulator, configured to provide synchronous clock input to the phase modulators and the intensity modulator;
at least one RF switch disposed between the RF clock and at least one of the plurality of the phase shifters associated with a phase modulator; and
an optical output port configured to provide an optical comb, the at least one RF switch configured to tune each corresponding phase shifter to thereby provide a tunable optical comb.

2. The optical comb generator of claim 1, further comprising:
a first RF splitter for synchronously coupling the RF clock to each of the plurality of phase shifter.

3. The optical comb generator of claim 2, further comprising:
a second RF splitter for coupling an output of first RF splitter to the at least one intensity modulator.

4. The optical comb generator of claim 3, further comprising:
an RF output port connected to the second RF splitter.

5. The optical comb generator of claim 2, wherein at least one of the phase shifters is coupled directly to an output of the first RF splitter.

6. The optical comb generator of claim 2, further comprising:
an RF amplifier for coupling each of the plurality of phase shifters to a corresponding phase modulator, and for coupling the second RF splitter to the at least one intensity modulator.

7. The optical comb generator of claim 6, further comprising:
at least one set of RF switches disposed between the RF amplifiers and the corresponding phase modulator of the plurality of the phase modulators, the at least one set of RF switches coupling the corresponding RF amplifier with the corresponding phase modulator via one of i) a low pass filter path, configured to remove harmonics of the RF clock and ii) a direct path.

8. The optical comb generator of claim 7, wherein at least one of the RF amplifiers is connected directly to the intensity modulator.

9. The optical comb generator of claim 1, further comprising:
a polarization controller optically coupled between the light input port and the plurality of phase modulators.

10. The optical comb generator of claim 1, the optical comb has at least 13 dBm output power operating over a tunable repetition range of 6-18 GHz.

11. The optical comb generator of claim 1, wherein at least one of the phase shifters is coupled directly to an output of the RF clock.

12. An optical comb generator, comprising:
a light input port configured to receive a continuous wave light from a laser source;
a plurality of phase modulators coupled to the light input port;
at least one intensity modulator coupled to the plurality of the phase modulators;
a plurality of phase shifters, each of the plurality of phase shifters coupled to a corresponding phase modulator of the plurality of phase modulators;
a radio frequency (RF) clock coupled to the plurality of the phase modulators and to the at least one intensity modulator, configured to provide synchronous clock input to the phase modulators and the intensity modulator; and
an optical output port coupled to the intensity modulator and configured to provide an optical comb.

13. The optical comb generator of claim 12, further comprising:
a first RF splitter for synchronously coupling the RF clock to each of the plurality of phase shifters.

14. The optical comb generator of claim 13, further comprising:
a second RF splitter for coupling an output of first RF splitter to the at least one intensity modulator.

15. The optical comb generator of claim 14, further comprising:
an RF output port connected to the second RF splitter.

16. The optical comb generator of claim 13, wherein at least one of the phase shifters is coupled directly to an output of the first RF splitter.

17. The optical comb generator of claim 12, further comprising:
an RF amplifier for coupling each of the plurality of phase shifters to a corresponding phase modulator, and for coupling the second RF splitter to the at least one intensity modulator.

18. The optical comb generator of claim 17, further comprising:
at least one set of RF switches disposed between the RF amplifiers and the corresponding phase modulator of the plurality of the phase modulators, the at least one set of RF switches coupling the corresponding RF amplifier with the corresponding phase modulator via one of i) a low pass filter path, configured to remove harmonics of the RF clock and ii) a direct path.

19. The optical comb generator of claim 18, wherein at least one of the RF amplifiers is connected directly to the intensity modulator.

20. The optical comb generator of claim 12, further comprising:
a polarization controller optically coupled between the light input port and the plurality of phase modulators.
